(19) United States
(12) Patent Application Publication
(10) Pub. No.: US 2007/0041184 A1
(43) Pub. Date: Feb. 22, 2007

(54) Artistic bulbs

(76) Inventors: Danny Lavy, Montreal (CA); Hsien-Te Chen, Shanghai (CN)

Correspondence Address: Edward D. Manzo;Cook, Alex, McFarron, Manzo,, Cummings & Mehler Ltd., 200 West Adams Street, Suite 2850, Chicago, IL, 60606, US

(21) Appl. No.: 11/270,244

(22) Filed: Nov. 9, 2005

Related U.S. Application Data
(60) Provisional application No. 60/709,489, filed on Aug. 19, 2005.

(51) Int. Cl. F21V 7/10

(52) U.S. Cl. 362/216; 362/567; 362/373

(57) ABSTRACT

Artistic bulb assemblies include a tubular neon sign type lamp containing neon or other noble gases. The (bent) tube is connected mechanically and coupled electrically to a housing having electrical components therein. The housing has a standard threaded base for connection to a standard line voltage as socket. The threaded base supports the housing and tube bulb. A backing member can be added behind the bent tube, and the tube can be shaped to resemble features on the backing member or shaped like its periphery. Another lamp assembly based upon the threaded base and attached housing combination uses fiber optics where the strands are embodied into ornamental objects forming the lamp and dispersing light from edge members of the lamp. A third embodiment includes a plasma discharge bulb.

### CROSS REFERENCE TO RELATED APPLICATION

This application claims priority from provisional patent application Ser. No. 60/709,489, filed Aug. 19, 2005, which is hereby incorporated herein by reference.

### FIELD OF THE INVENTION

The present invention relates to artistic lamps such as neon lamps, plasma lamps, and other lamps for special effects or ornamentation.

### BACKGROUND OF THE INVENTION

The history of lighting goes back thousands of years when candles were invented circa 3000 B.C. Later oil lamps were invented and were in use in biblical times. Improvements were made over the centuries, and then the kerosene lamp became popular in the 1800's. Also in that century, electric lighting was invented and developed. It is believed that in 1835, a light bulb based electric lighting system was demonstrated to the citizens of one community; that in 1841 arc-lighting was used as experimental public lighting in Paris, France; that in 1867, Becquerel demonstrated the first fluorescent lamp; and that in 1875 Henry Woodward patented the electric light bulb. Carbon filament or carbon thread incandescent lamps were developed or patented by Thomas Edison and Company in the later 1800's. Neon lamps were displayed at the World Columbian Exposition in Chicago, Ill. in 1893, designed and/or built by the famous Nikola Tesla. Further developments were made in the field of gas discharge lamps in the 1890's, a mercury vapor lamp in 1901, and in 1911, Georges Claude developed the neon lamp. Another fluorescent lamp followed in 1926.

The earliest roots of the neon sign actually date back to 1675 when the noted astronomer Jean Picard observed a faint glow in a mercury barometer tube. When the tube was shaken, a glow called “barometric light” occurred, but it was not then understood that the cause of the light was static electricity. By 1855, however, a German glassblower named Heinrich Geissler developed a Geissler tube in which gas was placed under low pressure. When electrical voltage was applied, the gas glowed. During the 1900's, electric discharge lamps were developed comprising a transparent container having a gas within it that was energized by an applied voltage and thereby made to glow. Neon is one of the gases used for this and is one of the so-called “noble gases” falling within Group VIII of the Periodic Table of the Elements. Those elements comprise helium, neon, argon, krypton, xenon, and radon.

The development of neon lighting has been completely different from the development of incandescent lighting used for home and office general illumination purposes. Neon lamps generally fall into two types, one being the small neon glow lamp, typically drawing power in the range from 0.4 to 3 watts. Those are typically used as indicator lights on electrical devices indicating the presence of voltage and are referred to generally as “neon glow lamps.” The other type is the well-known neon sign which has been used traditionally for commercial purposes. Generally, hollow glass tubes are used to make neon lamps and come in lengths of several feet. The tubes are shaped to fit the purpose: they are frequently shaped into words or depict an object or a company logo for example. Typically, the glass tube is cut, curved and angled, and then put through a process called “bombarding” where the tube is partially evacuated of air, short circuited with high voltage current until the tube reaches a certain temperature, then evacuated further to a certain vacuum level, and then back-filled with argon or neon. Additionally, mercury is injected into the tube. The so-called “neon” lamps can be used to produce numerous different colors. Neon gas itself glows with a characteristic red light, but other colors are available using argon, mercury and phosphors. “Neon tubes” generally refer to positive-column discharge lamps without regard to the specific gas filling. Mercury produces a blue light, carbon dioxide produces white, helium produces gold, and neon produces red. Different colors beyond those are obtained from using phosphor coated tubes. The mercury spectrum produces considerable ultraviolet light which is used to excite a phosphor coating on the inside of the glow tube, and phosphors are available in many different pastel colors. Thus, neon tube bulbs have been used to make fanciful or artistic creations or signage.

Typically, a specific transformer is required and electrodes extending from opposite ends of the lamp tube are connected by wires to the transformer output. One example of a connector for use with a neon lamp is shown in Jung U.S. Pat. No. 5,565,728 entitled “Neon Lamp with Flexible Connectors.” Another neon lamp arrangement is shown in Jung U.S. Pat. No. 5,489,813 entitled “Neon Lamp.” A neon lamp assembly is shown in Chian U.S. Pat. No. 5,504,397 disclosing a neon lamp, a frequency/voltage conversion circuit board for powering the neon lamp, and various other structures. An example of a power supply for a neon lamp is shown in, for example, Nilssen U.S. Pat. No. 5,387,845 entitled “Neon Lamp Power Supply.”

Generally, neon tube lamps of the sort used for signs or ornamentation have not been connected to the same sockets that have been used for normal incandescent lamps used for household lighting having a standard threaded socket. The present invention is directed to providing ornamental and artistic lamps that have a standard threaded base to be inserted into a standard threaded socket of the type used domestically for desk lights, floor lights, and ceiling fixtures used in residences and offices throughout the United States to receive line voltage (120 volts AC) and to operate therefrom.

### SUMMARY OF THE INVENTION

The present invention has multiple aspects. In one aspect, a lamp assembly is provided with a standard threaded base, a housing for a ballast or other electrical components extending from the threaded base, and a neon tube or other bulb or fixture extending upward (usually) from the housing.

According to further aspect of the invention, such a lamp assembly using preferably a neon tube may further include a backing member that extends upward from the same housing. Preferably the shape of the bulb corresponds in some way with the shape of the backing, and typically they have multiple colors and are not confined to rectilinear shapes. The backing may have different colored areas and may include holographic or reflective fanciful images, line drawings, or other graphic art. Preferably the backing member is displaced a short distance behind the bulb.

In another implementation, an artistic or ornamental object (for example silk flowers or the like) extends upward from the housing together with fiber optic strands that integrate with the other upward extending object.

In a further implementation, a plasma discharge lamp extends upward from the housing. Other artistic lamps can extend from this electrical housing connected to a threaded base member.

### BRIEF DESCRIPTION OF THE DRAWINGS

FIG. 1 represents a side view of the representative neon tube lamp according to aspects of the present invention.

FIG. 2 is a top view of the lid used in the lamp of FIG. 1.

FIG. 3 is a side expanded view with partial parts broken away of the lamp shown in FIG. 1.

FIG. 4 is a view of the underside of the main housing of the lamp shown in FIG. 1.

FIG. 5 is an elevational view of another lamp according to aspects of the invention.

FIG. 6 is a close-up view of portions of the lamp of FIG. 5.

FIG. 7 is a top view looking into the main housing of the lamp of FIGS. 5 and 6.

FIG. 8 is a bottom view of the lid of the lamp of FIGS. 5-6.

FIG. 9 is a view of one of the components of the lamp of FIG. 5.

FIG. 10 is another example of a lamp according to the present invention.

FIG. 11 represents a third embodiment of the present invention using a plasma discharge bulb.

FIG. 12 is a side view of the neon tube lamp of FIG. 1 modified in accordance with a further aspect of the present invention.

FIG. 13 is a front view of a backing member used in the embodiment of FIG. 12 and showing in broken lines the path traveled by the neon bulb in front of the backing member.

FIG. 14 represents an illustrative pattern that may be replicated numerous times in rectilinear fashion in the backing member of FIGS. 12 and 13.

FIG. 15 is a top view of the housing unit of Fig. the FIG. 12 embodiment, showing where the neon tube and backing member are connected.

FIGS. 16 and 17 are top and side views of an illustrative base to which the innovative neon lamp assembly of FIGS. 1-12 can be mounted.

### DETAILED DESCRIPTION OF THE PREFERRED EMBODIMENT

Preferred embodiments will now be described with the understanding, however, that the description is merely representative of the embodiments and use various aspects of the present invention. Further, the invention is not confined to the specific embodiments illustrated and described herein. Rather, the scope of the invention is to be determined by the appended claims.

### Description of a First Embodiment

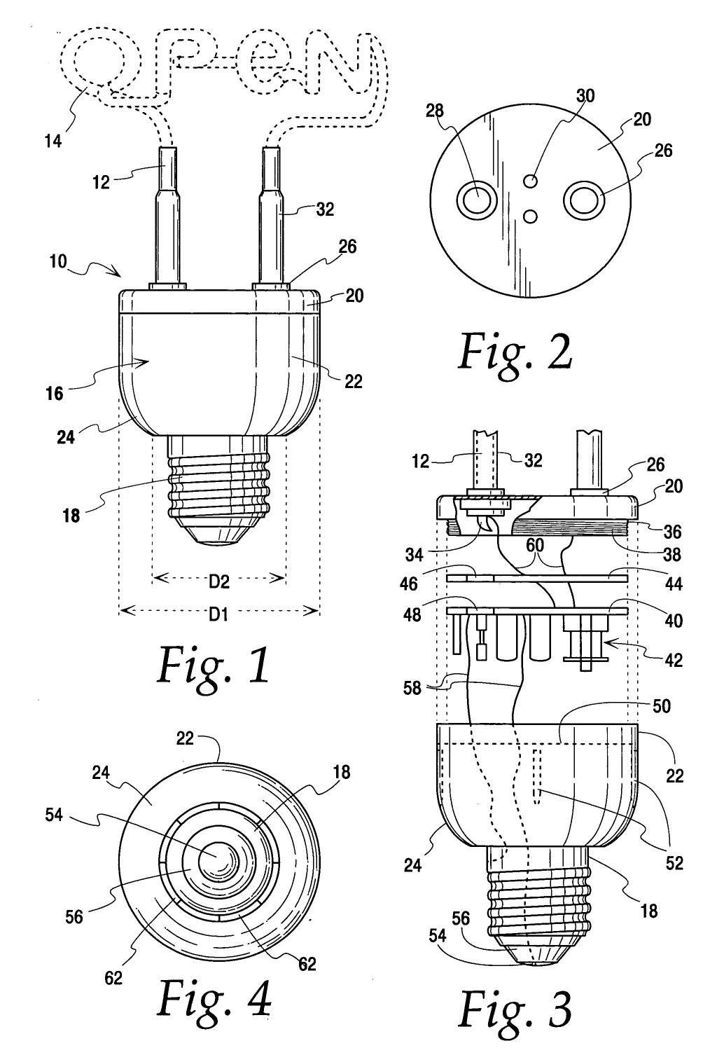

Referring to FIG. 1, a representative neon lamp assembly 10 is shown. Lamp assembly 10 comprises a shaped or bent tube 12 containing neon gas alone or with other gases and which may include a phosphor on the inside surface of tube 12. Tube 12 is shaped in an arbitrary or fanciful pattern shown in broken lines 14, in this case spelling the word “OPEN.” The shape of the tube can be virtually any shape and may comprise, for example, signs representative of zodiac symbols, candles, stars, bells, guitars or other musical instruments, animals, words, a heart representation or other body parts, trees, flowers, articles of manufacture (such as a car), mythical or fanciful objects (such as a snowman), articles of clothing (such as footwear), musical notes, “smiley” faces, butterflies, automobiles, or any other shape which one may wish. The tube 12 is connected mechanically to a housing 16 which in turn is connected to be supported by a standard electrical threaded base so that lamp 10 can be screwed into a standard 120 VAC electrical socket of the type customarily employed in the United States and Canada. Housing 16 also includes an upper lid 20 that is separable from a main body 22 of housing 16. Main body 22 in its preferred form is a cylinder of rotation having a first (outside) diameter d1 at its upper portion and a smaller diameter d2 at a lower portion. The diameter of the threaded base 18 is substantially one inch, corresponding with industry standards, and that diameter is slightly smaller than diameter d2. Preferably a curved transition region 24 extends from the upper portion having diameter d1. Transition region 24 reduces the diameter from d1 to diameter d2. Preferably the threaded base 18 and the housing 16 are concentric. Preferably lid 20 has the same outside diameter d1 as main body 22.

In the illustrated embodiment the upper surface of lid 20 is generally flat. It has a pair of equally sized rings 26 rising up slightly from the surface. The inside diameter of each ring 26 is slightly larger than the diameter of tube 12, and rings 2-6 are preferably spaced along a diameter of the lid 20 at a position to receive the ends of tube 12. Inside of rings 26 are apertures 28 extending completely through lid 20. As best seen in FIG. 2, lid 20 also includes one or more smaller apertures 30 that illustratively are also along a diameter and generally near the center of lid 20. As seen in FIG. 2, preferably apertures 30 are smaller than the larger apertures 28. The diameter of apertures 28 is sufficiently large to receive tube 12 including protective sleeves 32 fitted onto the two ends of the tube. Typically, protective sleeves 32 are made of plastic and are shrink-wrapped onto the ends of tube 12. Sleeves 32 extend into rings 26 and apertures 28. Customarily, protective sleeves 32 are glossy black, similar to standard black electrical tape.

FIG. 3 shows further structures of the illustrative neon lamp 10. FIG. 3 is an exploded view with parts broken away (from lid 20). Starting at the top of FIG. 3, protective sleeves 32 are shown extending substantially vertically upward from the substantially horizontal lid 20. The glass tube 12 is shown in broken lines on the left side of FIG. 3. Sleeves 32 extend completely through larger apertures 28, and the bottom tip 34 of glass tube 12 is shown where parts of lid 20 have been broken away in FIG. 3 for explanatory purposes. Lid 20 is preferably configured to engage main body 22 by a snap-fit configuration and thus may have a downwardly depending portion 36 with a diameter smaller than the outside diameter (d1) of lid 20. Depending portion 36 may include a ridge 38 to facilitate the snap-fit connection to main body 22.

Housing 16 contains a printed circuit board 40 which supports various electrical components for powering the neon tube 12. Such components may include, illustratively, resistors, diodes, a fuse, various capacitors, including high frequency capacitors, one or more transformers, a magnetic core and windings, and various resistors, all generally represented as electrical components 42. Preferably the discrete electrical components extend downward from printed circuit board 40 and the printed circuit connections are on the upper side of board 40. Preferably an insulating disk 44 made illustratively of paper or any other suitable insulating material is positioned between circuit board 40 (which preferably is circular in plan view) and lid 20. Preferably disk 44 includes an aperture 46 to be aligned with a similar aperture 48 in printed circuit board 40. These apertures allow the circuit board 40 to be placed closer to the lid 20 and fit directly beneath it, adjacent to its underside, without breaking off the glass tip 34.

Main body 22 has an inside diameter slightly larger than the diameter of circuit board 40 and slightly larger than the diameter of downward depending area 36 so that depending portion 36 can be inserted into main body 22 and so that ridge 38 can secure the engagement of these two parts of the housing 16. Main body 22 may have an internal longitudinal ridge 50 extending along its inside circumference near the top of main body 22 and may have generally vertically oriented stiffeners 52 spaced around the internal surface of main body 22.

Threaded base 18 is shown below main body 22. Base 18 includes a central conductor 54 at its lowest point to make electrical contact with a center prong of a standard electrical socket. It also includes a ceramic or other insulator disk 56 to provide electrical insulation between central conductor 54 and the metallic body of threaded base 18, all as customary with standard incandescent light bulbs for domestic use. Electrical wires 58 connect the metallic threaded body and central conductor of base 18 to appropriate circuit points on printed circuit board 40. The electrical circuitry 42 on circuit board 40 provides the necessary voltage, frequency, and current, all as customary for driving a tubular neon bulb, and these are connected to electrodes on tube 12 via wires 60.

A bottom view of housing 16 is shown in FIG. 4. This shows central conductor 54, insulator disk 56, threaded base 18, and the transition region 24 of main body 22. Preferably, housing 16 also includes a group of annular slots 62 located just at the top of the threaded base 18 between the transition region 24 and the metallic base 18 itself. These slots 62 promote airflow for cooling. Additionally, airflow occurs around the sides of printed circuit board 40 and through the aperture 48 therein. Air also flows through aperture 46 in insulating disk 44, and heated air may exit through small apertures 30 located on the generally flat upper surface of lid 20.

### Description of a Second Embodiment

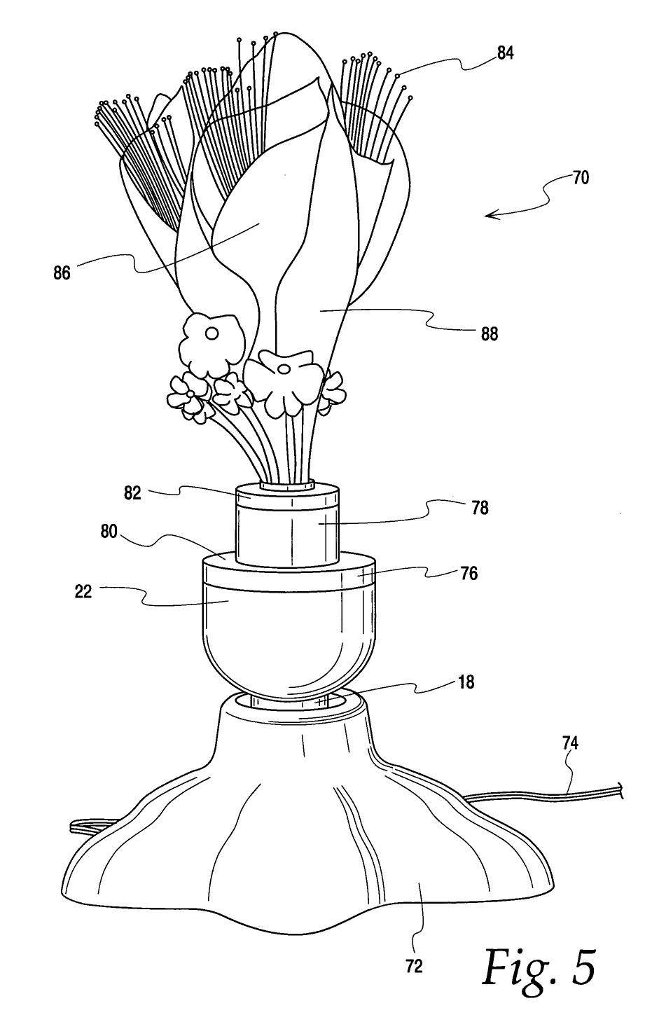

The threaded base 18 and housing 16 can be used for other artistic bulbs also. FIG. 5 shows an artistic lamp 70 having the same threaded base 18 supported in a mount 72 having a centrally located socket for receiving the threaded base 18 and providing a power connection by an AC cord 74. The same mount 70 can be used with the neon tube bulbs represented in FIGS. 1 through 4. Lamp 70 includes a similar housing using the same main body 22 having the same transition region 24 and having a lid 76 similar in some respects to lid 20. In particular, it includes the same general dimensions and the same downward depending portion and ridge for securing it to the main body portion 22. However, rather than having rings 26 with apertures 28 and 30, lid 76 includes a concentric sleeve 78 illustratively having a diameter which is slightly more than one inch (outside diameter). Sleeve 78 rises upward from a generally flat annulus 80 at the top of lid 76. Annulus 80 preferably is substantially flat and concentric with sleeve 78, and they are preferably a single, integrated unit. An inverted top-hat spacer 82 preferably made of nylon and having a central aperture extending therethrough has the same outside diameter as sleeve 78 at its brow portion with a downward depending inner sleeve which fits securely inside of the inside diameter of sleeve 78. Thus, sleeve 78 has a central aperture therethrough, and top-hat spacer 82 (which fits within that aperture) has another central aperture therethrough.

Top-hat spacer 82 supports and secures a floral or other arrangement therein with a plurality of several dozen or hundreds of fiber optic strands 84 and an arrangement of flowers 86 and leaves 88.

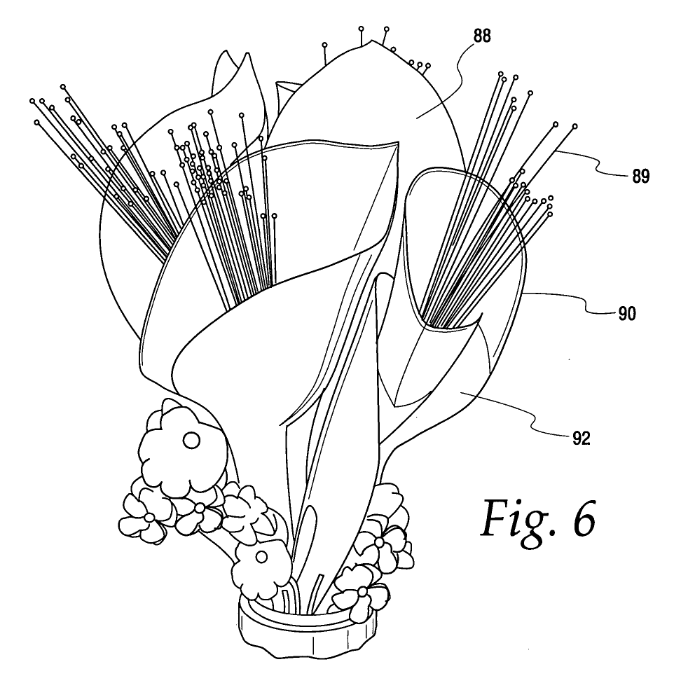

Preferably the leaves are made of silk or other material. Nylon or other mesh can be used if it is shaped. Illustratively, multiple colors can be used for the flowers, and preferably the leaves are all colored green or various shades of green, although other colors could be used for the leaf substrate. Preferably the fiber optic strands 84 are integrated with the floral arrangement. For example, with reference to FIG. 6, some of the fiber optic strands 84 may extend through the petals 90 of flowers. Preferably the fiber optic strands have multiple gauges. Relatively thicker strands can be free standing, as shown in FIG. 6, and extending through the middle of petals 90. Comparatively thin fiber optic strands 92 may be bonded to or otherwise be affixed to the backing of petals 90 and/or leaves 88. The numerous strands 84, whether thick strands 89 or thin strands 92, are assembled together at the base of the flower arrangement and all extend generally parallel to one another through the inverted top-hat spacer 82 and terminate at a single elevation, illustratively. For example, they may terminate at an elevation that is approximately equal to the elevation (height) of the top of annulus 80. They are, in particular, positioned so that light generated within the housing main body 22 will be conducted by the fiber optic strands and result in many dozens or hundreds of points of light arrayed throughout the borders of the artistic lamp 70. Thus, it can be seen in FIG. 6 that the ends of the thick fiber optic strands 89 are illuminated but also that the edges of the flowers 86, that is, the free edges of the petals 90 are illuminated as are the free edges of the leaves 88. This is because the thin strands 92 are bonded to or formed into those structures and conduct light that is generated within main body 22 up through the top-hat spacer 82 to the numerous locations of the structure supported by spacer 82.

The fiber optic strands can be any suitable material and may comprise, for example, a polypropylene or any other polymeric or other material suitable for fiber optic use. A relatively transparent plastic material is preferred.

While the lamp 10 illustrated in FIGS. 1-4 used a printed circuit board 40 having electrical components 42 for generating power suitable for driving a neon bulb, the embodiment of FIGS. 5-6 likewise uses a printed circuit board 40 with electrical components 42 but those electrical components further include an array of light emitting diodes (LEDs) and preferably LEDs generating different colors of light. Thus, for example, six LEDs can be used with one central LED surrounded by five other LEDs. Two of the LED's may be red, two may be green, and one may be blue, illustratively. Preferably the circuitry turns these differing bulbs on and off at different times so that, for example, at some times all of the lights are illuminated, and at other times, the blue lights only are illuminated, at some times only the red lights are illuminated, at other times only the green lights are illuminated, and at other times other combinations of two light colors are illuminated. Preferably each lighting combination stays illuminated for one-half to one second or more before changing to the next combination of lights. Circuitry for illuminating differing ones of light emitting diodes is well known and need not be discussed here.

FIG. 7 shows a representative plan view of the main body 22 of lamp 70 with the lid 76 removed. Thus, inside the cylindrical portion of body 22 one can see the stiffeners 52 discussed with reference to FIG. 3 and a printed circuit board 94 which is concentric with the circular periphery of main body 22. Discrete electronic circuit components 96 are represented and comprise various capacitors, resistors, and other circuit components for driving a group of light emitting diodes 100. A vertical circuit board 98 is also shown extending from horizontal pc board 40. It assists with the interconnection of the various circuit elements 96. The LED arrangement 100 may comprise red, blue and green LEDs and illustratively includes two of each such color indicated with the letters R for red, G for green, and B for blue in FIG. 7. Illustratively, one of the red LEDs is located in the center, and the five other LEDs surround the central member. Alternatively, any placement or arrangement of lights and colors can be used, and it is not necessary that light emitting diodes be used. Other light emitting elements can be used such as small incandescent bulbs or other light sources. The pattern need not be confined to a central region but may be distributed around the circuit board. They may be linearly arranged, or any other arrangement as desired. Preferably the electronic circuitry 96 illuminates the bulbs in a sequence, as noted above. Illustratively, circuit board 40 is situated approximately one-half inch below the upper rim of main body 22 and is held in place by dabs 102 of rubber cement or other adhesive placed in discrete locations around the periphery of the circuit board and contacting the inside face of main body 22. Illustratively main body 22 is made of plastic.

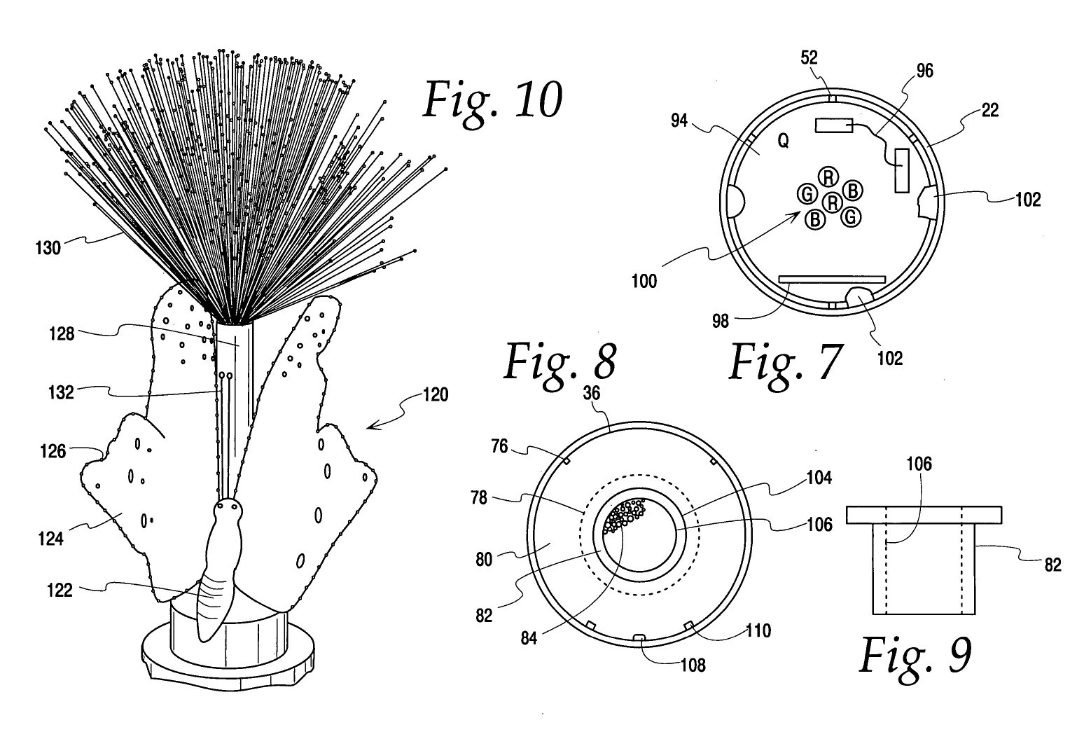

FIG. 8 is a view looking upward into lid 76. As with the lid 20 of FIG. 3, lid 76 includes a downward depending portion 36. The underside of annulus 80 is substantially flat. Shown in broken lines is the location of sleeve 78 which rises vertically upward from the other side of lid 76. The inside of sleeve 78 is an aperture 104 into which the inverted top-hat spacer 82 fits snugly. The gathered-together fiber optic strands 84 are tightly packed within an aperture 106 in the top-hat spacer 82. Preferably, they terminate at or near the bottom of spacer 82. A guide ridge 108 extends longitudinally along the inside of downward depending portion 36 along with further ridges 110.

FIG. 9 is a side view of inverted top-hat spacer 82 which may be made of nylon, neoprene, or another synthetic material, or any other preferably insulative material that is desired.

Thus, it will be appreciated that the fiber optic arrangement of the present invention provides a unique illuminated flower, with edges of leaves and flower petals changing color in accordance with the color changing scheme of LEDs 100. The fiber optic strands are distributed in three dimensions and are integrated into the physical structures that are bound together by the spacer 82. Additional wrapping around the fiber optic strands above the spacer 82 can be provided.

The fiber optic artistic lamps can be used for numerous other three dimensional objects such as a butterfly arrangement shown in FIG. 10. This artistic light bulb 120 includes the same structure below spacer 82 as lamp 70. However, the structure above it is somewhat different but uses similar principles. Thus, lamp 120 includes a body 122 of a butterfly or moth which is molded from a plastic or synthetic material. Extending beside body 122 is an arrangement of wings 124 which are a colored, plasticized fabric. The outside of wings 124 include the smaller gauge fiber optic strands 92 which terminate at the edges 126 of wings 124, thereby emitting light from the edges. Another fanciful structure having a stem 128 wrapped in a green plastic or electrical tape contains a “brush” 130 of larger gauge fiber optic strands, as seen in FIG. 10. Also, a pair of antennae 132 made of fiber optic strands can extend from the front of body 122.

### Description of a Third Embodiment

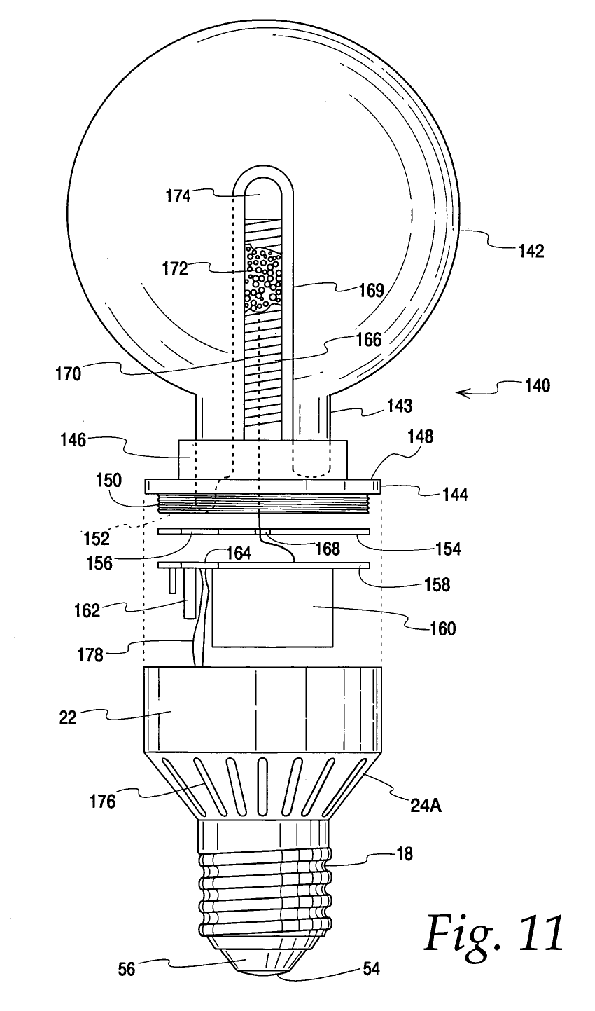

The present arrangement can also extend to a plasma discharge lamp 140, as illustrated in FIG. 11, an exploded view of a plasma discharge lamp usable in the present invention. This plasma discharge lamp includes a hollow glass globe 142 that is generally spherical extending from a generally cylindrical glass column 143. The glass structure 142, 143 is supported by a lid 144 having an upward rising sleeve 146 encircling and engaging the cylindrical glass portion 143. Preferably lid 144 is made of plastic and has an annular portion 148 beside the vertical sleeve 146. A downward depending portion 150 facilitates the engagement of lid 144 with main body portion 22. The glass globe 142, 143 includes a glass tip 152 shown in broken lines in FIG. 11. Glass tip 152 extends through a large central aperture of the lid and into the space circumscribed by the downward depending portion 150.

Another element in FIG. 11 is a circular insulating disk 154 much like insulating disk 44 used in the FIG. 3 embodiment. Insulating disk 154 includes a hole 156 to receive the tip 152 of the glass globe.

Beneath insulating disk 154 is a substantially circular printed circuit board 158 containing circuitry for powering the plasma lamp. Printed circuit board 158 generally includes discrete circuit elements extending downward from the circuit board with the printed circuit side facing upward, toward the insulating disk 154. In the preferred embodiment, an insulating box 160 encloses various circuit elements and other discrete circuit components 162 are outside box 160. Circuit board 158 includes a hole 154 so that glass tip 152 may extend therethrough without breaking the glass or interfering with the circuit. Extending from circuit board 158 is a drive wire or hot wire 166 that extends upward through a central hole 168 in insulating disk 154 upward through a reentry portion 169 of the globe 142. Within reentry portion 169 is a plastic sheath 170, and wire 166 extends upwards and into that sheath to make contact with a plurality of metal foil spirals 172 situated within sheath 170. The sheath 170 has been broken away in part to show some of the metal foil spirals 172. At the top of sheath 170 is a tip 174 fitted into the reentry portion 169.

Below the printed circuit board 158 with its circuit components 160, 162 is a main body 22 to which the lid 144 connects snuggly as described for the other embodiments. Rather than having a smooth transition region 24 as in the embodiment of FIG. 3, the embodiment of FIG. 11 includes a conical transition region 24a. Similarly, while the embodiment of FIG. 3 included cooling apertures in the form of annular slots 62 (see FIG. 4), a plurality of longitudinal vents 176 along the conical region 24a provide venting. Below conical region 24a is a threaded base 18 having the members discussed previously, such as the central conductor 54 and a ceramic or other insulator 56. A pair of electrical wires 178 connect the printed circuit board 158 to the line voltage that is connected to the base 18.

### Description of a Fourth Embodiment

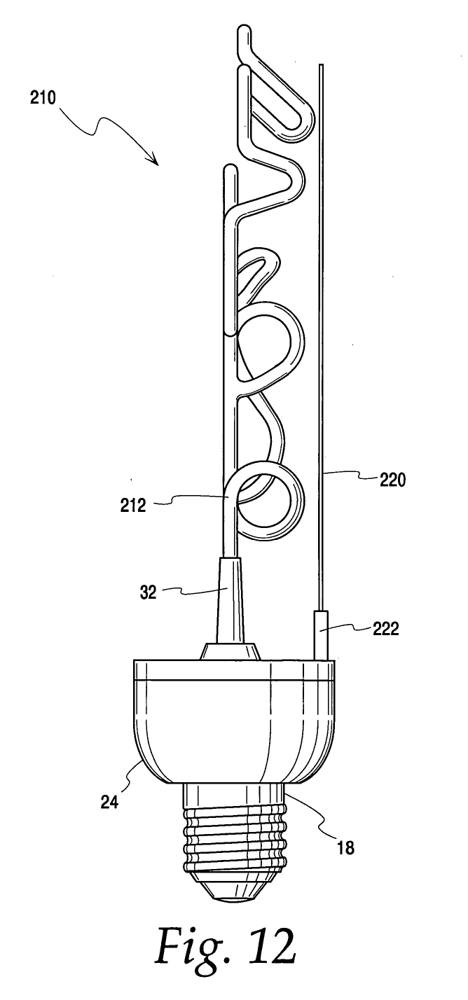

A fourth embodiment of the present invention has a tube lamp (such as neon or other gas discharge or fluorescent) with a reflective or other ornamental backing mounted on the same housing. Preferably the housing connects to a free-standing base and the combination thus described constitutes a free-standing lamp. An embodiment is described using the neon tube lamp assembly shown in FIG. 1 with additional parts. This is shown in FIGS. 12-15.

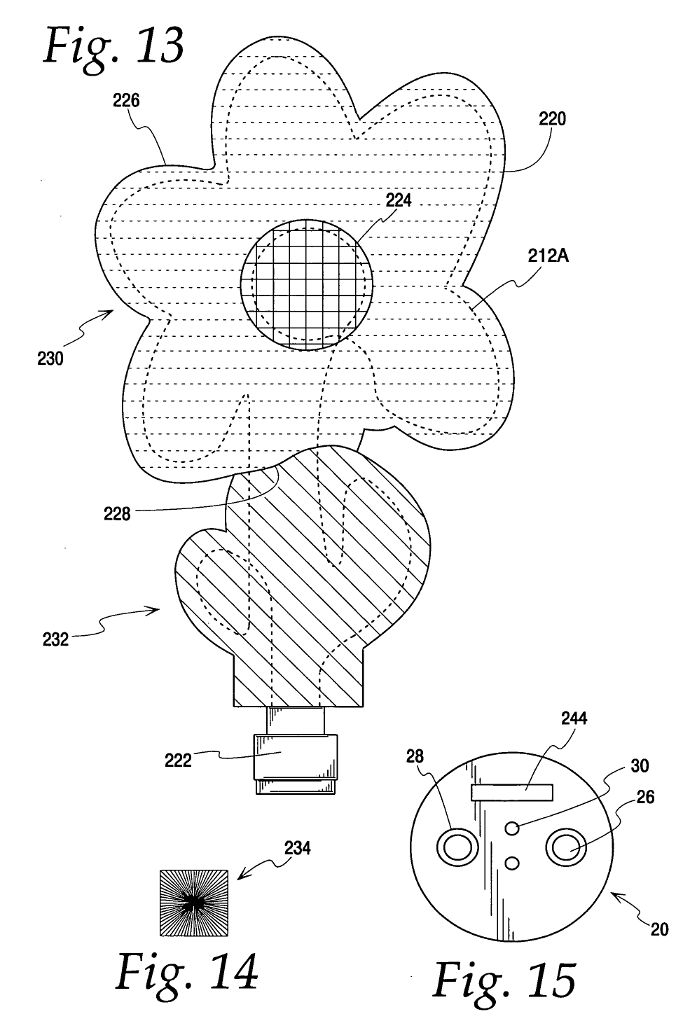

Referring to FIG. 12, a lamp assembly 220 is illustrated from a side elevation. The preferred combination includes the same housing 16 shown in FIG. 1 connected to the same threaded base 18. As with FIG. 1, housing 16 in FIG. 12 includes electronic components to drive a tube lamp, whether a neon tube 12 (FIG. 1) or a different tube lamp. The tube 212 in this embodiment can alternatively comprise, e.g., a fluorescent or other gas discharge bulb. The shape traced by tube 212 is not readily discernible from the side view of FIG. 12 but will be comprehended from viewing FIG. 13. Still referring to FIG. 12, however, sleeve 32 protects each of two ends of the tube 212 where they enter housing 16. The height of tube 212 may be in the range of several inches, nominally five to six inches, although there is no limitation intended by this nominal embodiment.

Situated behind tube 212 is a placard or backing member 220 which is preferably generally planar and standing generally upright from a mounting block 222 connected to housing 16. Backing member 220 may have a slight angle and may not be perfectly vertical (plumb), that is, it need not be perfectly perpendicular to a top surface of housing 16. Mounting block 222 may comprise a plastic or acrylic block into which the backing 220 is inserted. Mounting block 222 may be fastened by glue or other appropriate means to the top of housing 16. Alternatively, member 220 may be glued or otherwise fastened directly to housing 16.

FIG. 13 shows a front view of member 220. As can be seen or appreciated, the outline or outer periphery of backing member 220 emulates a flower. Considering a daisy, for example, which has white petals extending from a central yellow round structure, backing member 220 includes a central disk region 224 which preferably is colored yellow. Surrounding disk 224 is a structure resembling petals 226. Backing member 220 may be divided into an upper portion and a lower portion that meet at a dividing line 228. Thus, in this illustrative example, backing member 220 includes an upper portion 230 and a lower portion 232 separated by dividing line 228. Preferably, the lower portion 232 is colored green while the upper portion 230 is generally colored white or silver, except for central disk 224 which is preferably colored yellow. This color scheme is reminiscent of the coloring of the petal, the carpel or pistil, and the sepal and peduncle (stem) of the flower anatomy.

Backing member or placard 220 may be made of a plastic sheet having graphic features on its front surface. Backing member 220 may have a metallized front sheet adhered to the plastic sheet (or heavy duty cardboard). Alternatively, the graphic features may be printed, painted, or added by any other convenient process. The plastic or other sheet is cut to the desired shape.

The tube 212 in FIG. 13 is represented by broken line 212a which corresponds generally to a center line or axis of the irregularly shaped tube 212. Tube 212 may have an outer diameter of approximately ¼ of an inch but due to curves, variations are likely to exist. As can be seen from the side view (FIG. 12) and from the representation in FIG. 13, tube 212 has numerous curves that are further intended to emulate the depicted item, in this case a flower. As can be seen in FIG. 13, the upper portion of neon tube 212 is similar in shape to the periphery of the upper portion 230 of backing member 220 and, therefore, traces out at least portions of the petals of the flower. It also preferably includes a ring or partial ring in the center, having approximately the same dimensions as central disk 224.

Preferably neon tube 212 in this embodiment has multiple colors. Preferably the color of neon tube 212 above dividing line 228 is generally white, and it is generally green below dividing line 228. Thus, there can be a general correspondence not only of shape but also of color as between the neon tube 212 and the backing member 220 located behind the curved neon tube.

Preferably the front surface of backing member 220 is reflective also. As a consequence, a reflection of the neon (or other) tube is seen by the viewer along with directly viewing the tube itself.

Preferably the front surface on member 220 includes a pattern of reflective areas or cells 234. Typically cells 234 extend in a rectilinear pattern completely across the front face of member 220. FIG. 14 illustrates an enlarged view of one such cell 234 from which it can be seen that cell 234 includes an outer square shape formed by a plurality of triangles having their respective apices originating from a common center of the square. Adjacent triangular regions shown in FIG. 14 will have different reflective properties. The overall aesthetic effect on the viewer when neon tube 212 is emitting light is quite pleasing and conveys the connotation of an illuminated flower. The cells need not be rectangular, and any pattern can be used to promote the aesthetic effect.

Housing 16 need have no particular shape, but in the preferred embodiment comprises the cylinder of rotation described above with a generally flat lid 20 and having an inwardly curved portion 24 to provide a transition from the wider body portion of housing 16 to the narrower diameter of the threaded base 18. A top view of lid 20 is shown in FIG. 15. This view is with the neon tube 212, member 220, and mounting block 222 removed. As shown in FIG. 15, lid 20 includes the upstanding rings 26 having the larger apertures 28 extending therethrough and through the lid 20 to receive the neon tube 212. It also the smaller apertures 30 and a rectangular area 244 to receive the mounting block 222 which supports the backing member 220 in it somewhat upright position.

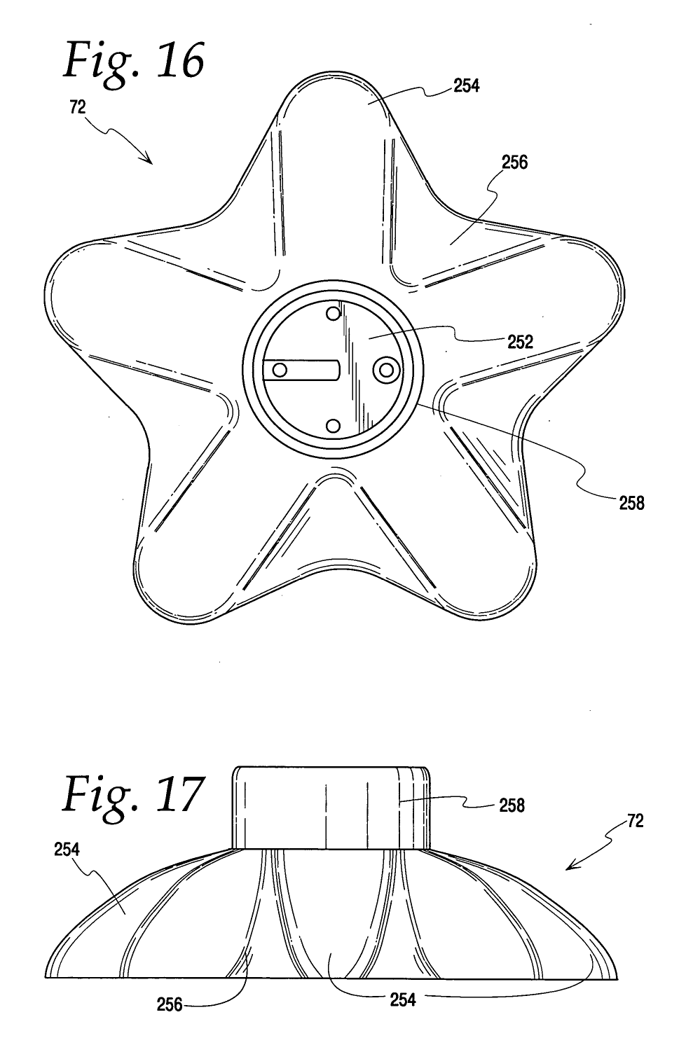

FIGS. 16 and 17 are top and side views of a base 72 to support the combination 210. It will be understood that any base can be used that provides a suitable socket into which the threaded base 18 can be inserted. In the present embodiment, a threaded socket 252 is provided having standard Underwriter Laboratories approved configuration. The outline of base 72 may have an artistic shape, and in this case somewhat suggestive of a starfish having five “legs” 254 with recesses 256 between adjacent legs. A raised central region 258 is generally centrally located. The top of raised central region 258 may be smoothly curved. Preferably the outer surface of base 72 is a black synthetic (plastic) having, illustratively, a matte finish. It will be appreciated that other shapes and materials can be used for supporting the combination tube assembly 210.

It will be understood that the lamp assembly 210 (of tube 212 with backing member 220) together with base 72 constitutes a lamp that can be placed on a flat surface. Not shown is an electrical A/C cord 74 equipped with an in-line on/off switch, but it will be understood that one is provided (as shown in FIG. 5).

The invented combination can be used to form artistic but functional lamps based upon any graphic image or theme. For example, an angel can be simulated by having a line drawing of an angel on backing member 220 with the outer periphery of member 220 corresponding to the silhouette or outer periphery of the angel. On the backing member 220 are lines representing arms, a face, wings, or other desired features. The hair can be colored as desired, illustratively yellow, and the represented garments on the angel can be white or other color(s) as desired. The neon tube 212 corresponds generally to the silhouette shape of the angel and traces out the outer garment or body portion of the angel, the wings, and the head.

A butterfly can be represented as another example. The wings of the butterfly can be colored vividly on the front of member 220, and the shape of member 220 also corresponds to the shape of the butterfly. Likewise, the shape of (preferably neon) tube 212 corresponds to the silhouette of the butterfly and may have any suitable color(s).

As used in this patent specification, the reference to the shape of the tube 212 “corresponding” to the silhouette or outer periphery of the member 220 does not require absolute identity of size but rather only general or approximate correspondence in size and general shape. Indeed it is preferable sometimes for the tube 212 to be slightly smaller than the other silhouette of the backing member 220. Additionally, the tube 212 can be a manmade work product having variations. Thus, a high degree of precision in the outer shapes of tube 212 and backing member 220 is not required, but general similarity of shape is intended.

Alternatively or in addition, the tube 212 may also, in addition to tracing some of the outer silhouette, be shaped to represent some inner features of the object being depicted as, for example, the central disk 224 in the case of the flower shown in FIG. 13.

Another example is a holly leaf. For this, the backing member 220 may have multiple colors, principally earth tones, and the (neon) tube may be partially orange and partially another color such as white or green.

A dolphin may be represented using, illustratively, blue neon.

A snowman can be represented using a white neon tube shaped like a snowman wearing a hat, and the backing member can include graphic representations of eyes, a mouth, and garments such as a scarf or the like.

A Christmas tree can be represented having multiple colors, principally green.

Thus it will be appreciated that the shape of tube 212 is usually not rectilinear, i.e., not usually a simple rectangle, but rather corresponds to the (non-rectilinear) outline of a leaf, flower or other plant portion, an animal, a star or other extraterrestrial object, a fictitious character (Santa Claus, Snowman, Easter Bunny, Tooth Fairy, Halloween Witch, etc.) or a supernatural being (e.g., an angel), or other things to be represented.

It will be understood that numerous graphic objects or images, whether natural or supernatural, can be fashioned using this embodiment of the present invention to provide a highly aesthetic lamp with unique features resulting from the synthesis of a neon or other gas tube formed according to various shapes of the item being depicted, in combination with an offset backing member that frequently will have printed or otherwise fashioned on it further elements or the same elements of the item being depicted, typically in more than one color. Preferably, the backing member is reflective and may include a holographic component, thereby adding to the visual impact of the combination. The backing member can also be used with the fiber optic lamp assemblies described with reference to FIGS. 5-10.

In all of the embodiments discussed above, the lid and main body are formed of any suitable synthetic or plastic. It will be appreciated that the foregoing description of differing embodiments is illustrative of the wide variety of lamps that can be achieved using aspects of the present invention. While a standard threaded base has been used on various incandescent light bulbs and on fluorescent light bulbs designed to be replacements for incandescent light bulbs, the assemblies described herein offer different choices of artistic bulbs to the consumer market. The scope of the protection to be afforded to the present invention is preferably set forth in the following claims.

1. A lamp assembly comprising:
a bent tube containing a gas for gas discharge light emission;
a housing;
said bent tube being connected to said housing;
said housing containing electrical components for powering said gas discharge light emission;
a screw-type base extending from said housing, said base being configured for screwing into a standard electrical socket of the type providing line voltage.

2. A lamp assembly comprising:
a bent tube containing a Group VIII gas;
a housing having a generally flat upper surface and a pair of apertures in said flat upper surface;
said bent tube having two ends, each of said two ends extending through said pair of apertures and into said housing;
said two ends being secured to said housing and extending in a generally upright manner from said generally flat upper surface for at least a portion of the course of travel of said bent tube;
a circuit board contained within said housing and supporting electrical components;
said bent tube having electrical terminals associated with each of said two ends of said bent tube, said electrical terminals being located beneath said generally flat upper surface of said housing;
respective first electrical connections between said bent tube electrical terminals and said circuit board;
a screw-type metallic base extending downward from said housing, said base being configured for screwing into a standard electrical socket of the type providing line voltage; and
respective second electrical connections coupling said base to locations on said circuit board.

3. The lamp assembly of claim 2 further comprising an insulator sheet interposed between said generally flat upper surface and said circuit board.

4. The lamp assembly of claim 3 wherein said insulator sheet and said circuit board each include respective apertures therein having diameters approximately equal to a diameter of said bent tube, said apertures being aligned with each other.

5. The lamp assembly of claim 4 wherein an end of said bent tube extends through at least one of said apertures in said insulator sheet and said circuit board.

6. The lamp assembly of claim 2 wherein said housing includes an upper portion and a lower portion,
said upper portion including said generally flat upper surface, said upper portion engaging said lower portion,
said circuit board being located in said lower portion.

7. The lamp assembly of claim 2 further including first and second protective sleeves extending from points at approximately the ends of said bent tube through said generally flat upper surface, said sleeves being visible from the exterior of said assembly.

8. The lamp assembly of claim 2 further including first and second rings extending upward from said generally flat upper surface, said bent tube extending through said rings.

9. The lamp assembly of claim 2 wherein said housing includes air vents.

10. The lamp assembly of claim 9 wherein said air vents are arranged annularly at a lower portion of said housing.

11. The lamp assembly of claim 10 wherein said air vents are located approximately at the intersection of said screw-type metallic base and a lower portion of said housing.

12. The lamp assembly of claim 2 wherein said housing generally comprises a cylinder of rotation having an upper diameter and a lower diameter, said upper diameter being larger than said lower diameter, and including a transition region, wherein said screw-type base extends downward from a lower portion of said housing, a diameter of said screw-type base being smaller than said lower diameter.

13. The lamp assembly of claim 2 wherein said tube contains neon.

14. The lamp assembly of claim 2 wherein said tube contains neon and another gas.

15. The lamp assembly of claim 2 wherein the shape of said tube spells a word.

16. The lamp assembly of claim 2 wherein the shape of said tube depicts an object.

17. A lamp assembly comprising:
a housing containing electrical components;
a screw type conductive base extending downward from said housing, said base being configured for screwing into a standard electrical socket of the type providing line voltage;
a plurality of fiber optic bundles extending from said housing;
at least one lighting element contained within said housing and being powered by said line voltage and circuitry contained on a circuit board within said housing;
a plurality of fiber optic strands bundled together at a first location entering said housing and positioned to receive light emitted from said at least one light source;
an object supported by said housing;
wherein some of said fiber optic strands are integrated into said object to provide light emitting from edges of said object.

18. The lamp assembly of claim 17 wherein other ones of said fiber optic strands are not integrated as part of said object and emit light from freestanding locations relative to said objects supported on said housing.

19. A lamp assembly comprising:
a housing containing electrical components for powering a lamp;
a screw type base extending from said housing, said base being configured for screwing into a standard electrical socket of the type providing line voltage;
a printed circuit board contained within said housing and being coupled electrically to receive line voltage from said base, said circuit board having an output conductor;
a generally spherical shaped globe supported by said housing and having a reentrant portion extending upward into said globe;
said output conductor extending into said reentrant portion and sufficient to operate said bulb as a plasma discharge lamp.

20. A lamp assembly comprising:
a tubular bulb;
a housing containing electrical components for operating said tube bulb;
a backing member coupled to said housing and extending generally upward;
wherein the backing member includes a graphic representation of an item and wherein a periphery of said backing member corresponds to the shape of the item;
the bulb having a shape that generally corresponds, at least in part, to at least a portion of item represented on said backing member;
the backing member being spaced from the bulb.

21. The lamp assembly of claim 20 wherein at least a portion of said bulb has a shape corresponding to the periphery of the backing member and wherein said representation includes colored regions.

22. The lamp assembly of claim 20 wherein said representation includes a line drawing.

23. The lamp assembly of claim 20 wherein the bulb includes more than one colored segment.

24. The lamp assembly of claim 20 wherein a portion of the bulb follows the shape of an interior component of the item to be represented.

25. The lamp assembly of claim 20 wherein the backing member is generally parallel to the bulb but offset therefrom.

26. The lamp assembly of claim 20 wherein the backing member is reflective.

27. The lamp assembly of claim 20 wherein the backing member includes holographic elements.

28. The lamp assembly of claim 20 further comprising a threaded electrical base.

29. The lamp assembly of claim 20 wherein said tube bulb comprises a neon tube.

30. A lamp assembly comprising:
a light-emitting bulb;
a housing containing electrical components for operating said bulb;
a backing member coupled to said housing and extending generally upward;
wherein the backing member has a periphery (silhouette) approximately corresponding to the shape of an item to be represented;
the bulb having a shape that generally corresponds, at least in part, with at least a portion of the periphery of said backing member;
wherein the backing member is generally parallel to a portion of the bulb but offset therefrom.

31. The lamp assembly of claim 30 wherein said backing member includes a graphic representation of the item to be represented.

32. The lamp assembly of claim 31 wherein at least a portion of said bulb corresponds in shape to and is positioned generally in front of an interior feature of the graphic representation on said backing member.

33. A lamp assembly comprising:
an upstanding backing member containing a graphic image;
a light-emitting bulb;
a housing containing electrical components for operating said bulb;
said backing member and said bulb both being coupled to said housing and extending generally upward;
wherein the backing member has a periphery (silhouette) approximately corresponding to the shape of an item to be represented;
wherein the bulb traverses a course which accents one or more features of the graphic image;
wherein the backing member is generally parallel to a portion of the bulb but offset therefrom.

34. The lamp assembly of claim 33 wherein said backing member includes a graphic representation of the item to be represented.

35. The lamp assembly of claim 34 wherein at least a portion of said bulb corresponds in shape to and is positioned generally in front of an interior feature of the graphic representation on said backing member.

36. The lamp assembly of claim 34 wherein said bulb is a neon bulb shaped to correspond to at least a portion of the periphery of the backing member;
wherein at least a portion of said backing member is reflective; and
wherein said graphic representation on said backing member includes at least one colored region or object.
